(19) United States
(12) Patent Application Publication
(10) Pub. No.: US 2003/0136865 A1
(43) Pub. Date: Jul. 24, 2003

(54) Wireless monitoring of conical crusher components

(75) Inventor: Vijia K. Karra, Franklin, WI (US)

Correspondence Address: FOLEY & LARDNER, 777 EAST WISCONSIN AVENUE, SUITE 3800, MILWAUKEE, WI, 53202-5308, US

(73) Assignee: Metso Minerals Industries, Inc.

(21) Appl. No.: 10/053,981

(22) Filed: Jan. 22, 2002

(51) Int. Cl. B02C 25/00

(52) U.S. Cl. 241/33; 241/207

(57) ABSTRACT

A cone crusher includes a frame, a shaft supported by the frame, and a head coupled to the shaft. An eccentric is rotatably coupled to the shaft and an eccentric bushing is coupled to the eccentric. A temperature sensor is attached to the eccentric bushing and directly measures the temperature of the eccentric bushing. A wireless transmitter is coupled to the temperature sensor, wherein the wireless transmitter transmits the measured temperature data.

### FIELD OF THE INVENTION

The present specification generally relates to rock crushers. More specifically, the present specification relates to a method of monitoring the status of conical crusher components, such as the eccentric bushing.

### BACKGROUND OF THE INVENTION

Rock crushers, such as cone crushers or primary gyratory crushers, generally include an eccentric assembly that rotates about a stationary main shaft and imparts gyratory motion to a head assembly. Material to be crushed is loaded into a feed hopper that feeds into the crusher cavity. The material, generally rock, is crushed between a bowl liner disposed in the bowl assembly and a mantle on the crusher head assembly.

To crush rock between the head assembly and the bowl assembly, gyratory motion is imparted to the head assembly to alternately widen and narrow the gap between the mantle and the bowl liner. The gyratory motion may be imparted via an eccentric that rotates with respect to a stationary shaft and directly imparts the eccentric motion to the head assembly. Alternatively, an eccentric assembly made be used to impart gyratory motion to a movable shaft, which in turn imparts gyratory motion to the head assembly. In either case, a frame supports the shaft and head assembly, and a countershaft or other driving mechanism drives the eccentric assembly.

The eccentric generally rotates at a high rate of speed (e.g., 200-400 rpm) and includes a bushing disposed between the eccentric and the shaft, permitting the rotation. Although the interface between the eccentric bushing and the shaft is lubricated, the friction between the eccentric bushing and the shaft generates a substantial amount of heat that must be dissipated during crusher operation. If the eccentric bushing overheats, the bushing materials (e.g. the lead in a leaded bronze alloy) may fail by melting or vaporizing, and can result in overall crusher failure, in particular by seizing with the main shaft.

Eccentric bushing failure due to overheat may result in a substantial period of crusher inoperability as the eccentric bushing is located deep within the crusher, resulting in substantial time and expense in accessing the bushing for repair or replacement. Due to the expense and inoperable machine time due to bushing failure, various methods of monitoring the status of the eccentric bushing may be utilized in an attempt to predict and prevent eccentric bushing failure.

One conventional monitoring method utilizes infrared techniques to monitor the thermal image of the bushing. However, the eccentric bushing is located at an interior portion of the rock crusher, which makes infrared techniques difficult. Further the bushing is surrounded by several other metallic members, which interfere with the thermal image of the eccentric bushing. Accordingly, infrared imaging of the eccentric bushing has not been successful.

Another monitoring technique utilizes hardwired temperature sensors to monitor eccentric bushing temperatures. However, the hardwired temperature sensors have not been feasible due to the high speed rotary motion of the eccentric bushing and the location of the bushing deep within the crusher.

Due to the difficulty of making direct temperature measurements, attempts have been made to utilize indirect temperature measurement, such as by measuring the temperature of an oil lubricant at a drain point. Measurement of the oil temperature at a drain point may be accomplished via hardwired thermocouples disposed beneath the eccentric bushing. However, to predict bushing failure utilizing the indirect temperature measurement method, bushing failures must be correlated with drained oil temperatures to develop a rule for issuing a warning on impending bushing failure. It is further complicated by the fact that the drained oil temperature varies as a function of the oil cooling cycle, crusher loading, and other variables. Further still, depending on the crusher type, the onset of eccentric failure may occur at different locations, for example, near the top of the eccentric bushing. In the case where the onset of eccentric bushing failure typically occurs near the top of the eccentric bushing, the measurement of drained oil temperature from the bottom of the eccentric bushing is less useful for predicting eccentric bushing failure.

The problems associated with monitoring eccentric bushing temperature are also applicable to other moving rock crusher components, such as head bushings, countershaft bushings, and various thrust bearings among other components.

Accordingly, there is a need for an apparatus and method for direct measurement of rock crusher component temperatures. Further, there is a need for a temperature measurement device that is not hardwired to a data collection unit so that direct temperature monitoring may be accomplished for rotating components. Further still, there is a need for a temperature measurement device that may be located at a variety of positions on an eccentric bushing or other crusher components.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

One embodiment of the invention relates to a cone crusher. The cone crusher includes a frame, a shaft supported by the frame, a head coupled to the shaft, and an eccentric rotatably coupled to the shaft. An eccentric bushing is coupled to the eccentric, and a temperature sensor is attached to the eccentric bushing that directly measures the temperature of the eccentric bushing. A wireless transmitter is coupled to the temperature sensor, wherein the wireless transmitter transmits the measured temperature data.

Another embodiment of the invention relates to a rock crusher having a frame and a crushing head. A motive of force is coupled to the crushing head to effectuate motion designed to crush rock. A bushing is provided intermediate a rotating part and a stationary part of the rock crusher, wherein the bushing rotates with the rotating part, the bushing including a temperature sensor that directly measures the temperature of the bushing. A wireless transmitter is coupled to the temperature sensor, wherein the wireless transmitter transmits temperature data.

A still further embodiment of the invention relates to a method of directly measuring the temperature of a moving part within a cone crusher having a frame, a shaft, and a crushing head. The method comprises the steps of embedding a temperature sensor in the moving part, coupling a wireless transmitter to the temperature sensor, directly measuring the temperature of the moving part, and transmitting the temperature from the wireless transmitter to a receiver.

A still further embodiment of the invention relates to an eccentric bushing for a rock crusher. The eccentric bushing includes a bushing, a temperature sensor embedded in the bushing, and a wireless transmitter attached to the bushing and coupled to the sensor.

Alternative exemplary embodiments of the invention relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a cross-sectional view of a rock crusher;

FIG. 2 is a cross-sectional view of an eccentric assembly and eccentric bushing;

FIG. 3 is a perspective schematic view of an eccentric bushing having a temperature sensor and wireless transmitter;

FIG. 4 is a cross-sectional view of a crusher head and head bushing;

FIG. 5 is an exploded schematic view of a socket and socket liner;

FIG. 6 is a sectional view of a countershaft assembly;

FIG. 7 is a sectional view of a rock crusher;

FIG. 8 is a cut away perspective view of the eccentric assembly of FIG. 7; and

FIG. 9 is a sectional view of a rock crusher.

### DETAILED DESCRIPTION OF PREFERRED EMBODIMENTS

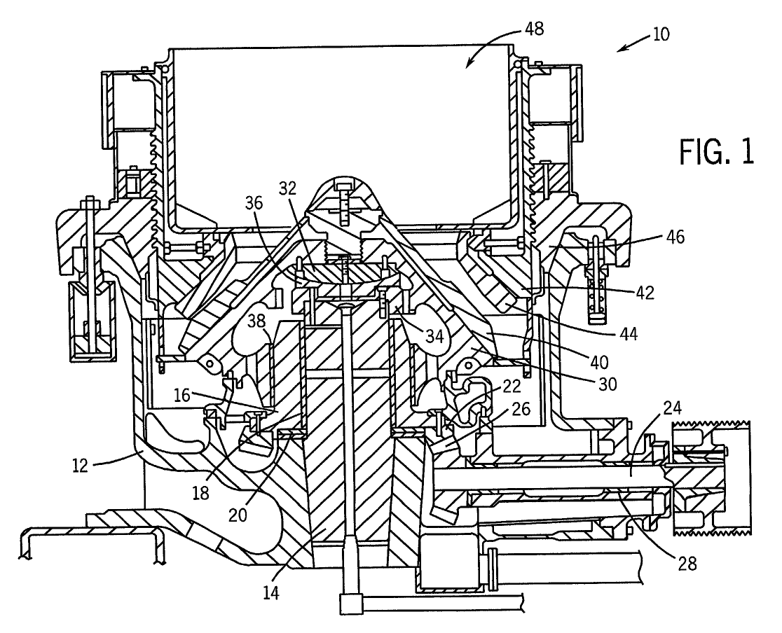

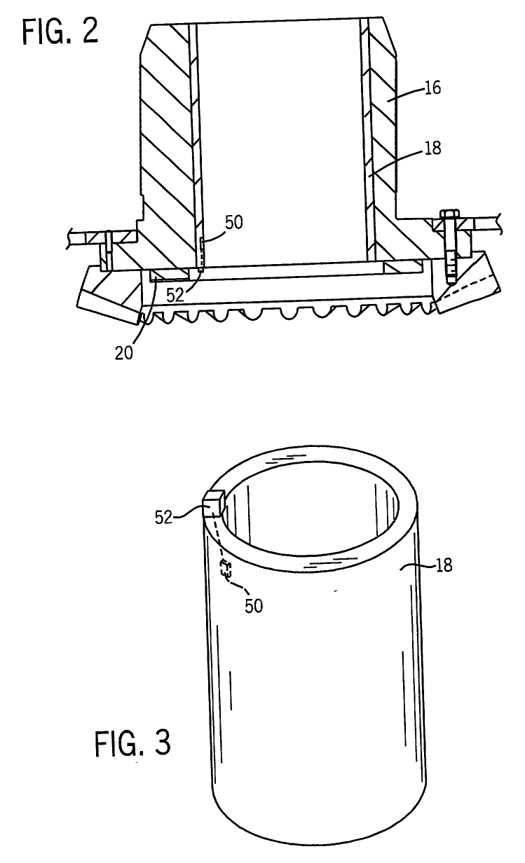

Referring to FIGS. 1 and 2, a crusher 10 includes a main frame 12 that supports the components of the crusher 10 including a main shaft 14. In the embodiment depicted in FIG. 1, the main shaft 14 is stationary and an eccentric 16 is rotatably disposed about the main shaft 14. The eccentric 16 rotates with an eccentric bushing 18 about main shaft 14. A thrust bearing 20 supports the eccentric 16. Crusher 10 can be embodied as a conical crusher manufactured by Metso Minerals Inc., such as an HP® Series cone crusher, including a temperature sensor 50 (FIG. 3) for advantageously monitoring the temperature of eccentric bushing 18. In an alternative embodiment, crusher 10 can be designed to have a rotatable shaft similar to main shaft 14.

A gear 22 is fixed to eccentric 16 and is driven by a countershaft 24 having a pinion 26 engaged with gear 22. The countershaft 24 may be driven by any suitable motive force. Countershaft 24 is disposed within a countershaft bushing 28 that permits rotation of countershaft 24.

A head 30 is disposed above main shaft 14 and includes a head ball 32 that is axially supported by a socket 34 and socket liner 36 disposed on main shaft 14. A head bushing 38 is rotatably coupled to eccentric 16 and transmits motion from eccentric 16 to head 30. Head 30 includes a mantle 40 that serves as a crushing surface.

A bowl 42 supported by main frame 12 includes a bowl liner 44 that serves as a crushing surface opposite mantle 40. An adjustment ring 46 permits vertical adjustment of bowl 42 to change the gap between bowl liner 44 and mantle 40, thus changing the crusher 10 setting.

A feed hopper 48 serves as a receptacle for the input of rock to be crushed, and feeds the rock into the cavity between mantle 40 and bowl liner 44.

In operation, countershaft 24 drives eccentric 16 to impart gyratory motion to head 30. Material to be crushed is fed into feed hopper 48, is crushed between mantle 40 and bowl liner 44, and exits out of crusher 10.

Referring to FIG. 3, in an exemplary embodiment of the invention, eccentric bushing 18 includes a sensor, such as temperature sensor 50. The temperature sensor 50 may be embedded into eccentric bushing 18 to directly measure the internal temperature of eccentric bushing 18. The temperature sensor 50 may be connected to a wireless transmitter 52, which may be attached to a flat edge of eccentric bushing 18. To facilitate the placement of temperature sensor 50, temperature sensor 50 may be a small size temperature sensor such as a thin-film metallic type or fiberoptic type. The wireless transmitter 52 is utilized to transmit the measured temperature data to a receiver (not shown) placed in any position suitable for receiving the transmitted signals.

In order to utilize temperature sensor 50 in conjunction with wireless transmitter 52 on components within crusher 10, several obstacles must be overcome. Components such as eccentric bushing 18 are located deep inside crusher 10 and are not easily accessible from outside crusher 10. Accordingly, temperature sensor 50 and wireless transmitter 52 may be installed on eccentric bushing 18 (or other components) prior to installation on crusher 10. Further, the environment proximate to components such as eccentric bushing 18 is hostile, as such components are surrounded by oil and operate at a high temperature. Accordingly, unless properly chosen and protected, temperature sensor 50 and wireless transmitter 52 may be subject to operational failure due to the hostile environment. Further still, available space on components such as eccentric bushing 18 is severely limited, and accordingly conventional direct temperature measurement devices such as thermocouples present difficulties due to their size and wiring needs.

In an exemplary embodiment, wireless transmitter 52 is attached via an adhesive or other suitable fastening method (such as by screws) to eccentric bushing 18. To address the space limitations, wireless transmitter 52 may have a size of approximately one inch in length and a height and a width of approximately one-half inch each. The small size permits placement of wireless transmitter 52 in the space between the flat surfaces of the bushings, such as eccentric bushing 18 and other components.

To overcome the issues presented by the hostile environment, temperature sensor 50 may be embedded into eccentric bushing 18, one to two inches deep in an exemplary embodiment. Embedding the temperature sensor 50 protects the temperature sensor 50 from the heated lubricant while also permitting the direct temperature measurement of eccentric bushing 18. Embedding the temperature sensor 50 into eccentric bushing 18 is also applicable to other components on crusher 10 where the hostile environment is at issue.

Temperature sensor 50 and wireless transmitter 52 may be connected by a small wire, or may be integrated as a single unit.

In an exemplary embodiment, the receiver is disposed outside crusher 10, and accordingly wireless transmitter 52 has a range of approximately three to five feet for transmitting the measured data. The receiver may be a fixed unit, or a handheld mobile unit. Further, the receiver may be used to amplify the signal transmitted by wireless transmitter 52 and further transmit the signal to other devices, such as a computer that may be utilized to analyze temperature data.

In an exemplary embodiment, the wireless transmitter 52 may be an optical sensor transmitter. Further, because wireless transmitter 52 is located on a rotating component, it may include its own power source, such as an integrated battery unit.

Depending on the type of crusher 10, temperature sensor 50 may be placed in differing locations on or in eccentric bushing 18 where direct temperature measurement is desired. In particular, it is desirable to measure the eccentric bushing 18 temperature at points of maximum heat load, where material failure is most likely to occur.

Temperature sensor 50, in conjunction with wireless transmitter 52, may be utilized in other locations within crusher 10 wherever direct temperature measurement is desirable and hardwired temperature sensors are disadvantageous.

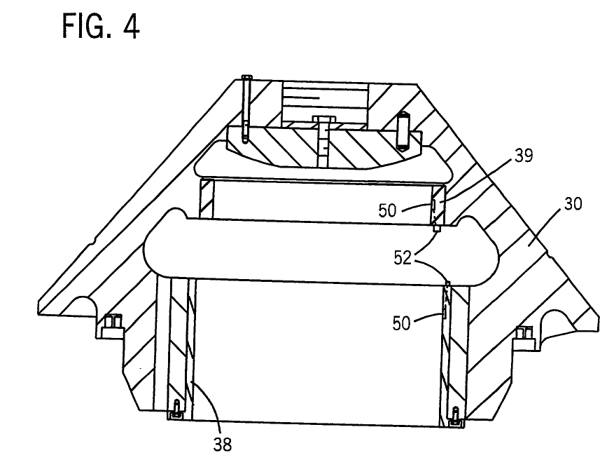

Referring to FIG. 4, lower head bushing 38 and upper head bushing 39 are subject to high heat loads during operation of crusher 10 due to the high rotational speed of eccentric 16 imparting gyratory motion to head 30. Accordingly, lower head bushing 38 and upper head bushing 39 are likely candidates for the use of wireless transmitter 52 and temperature sensor 50.

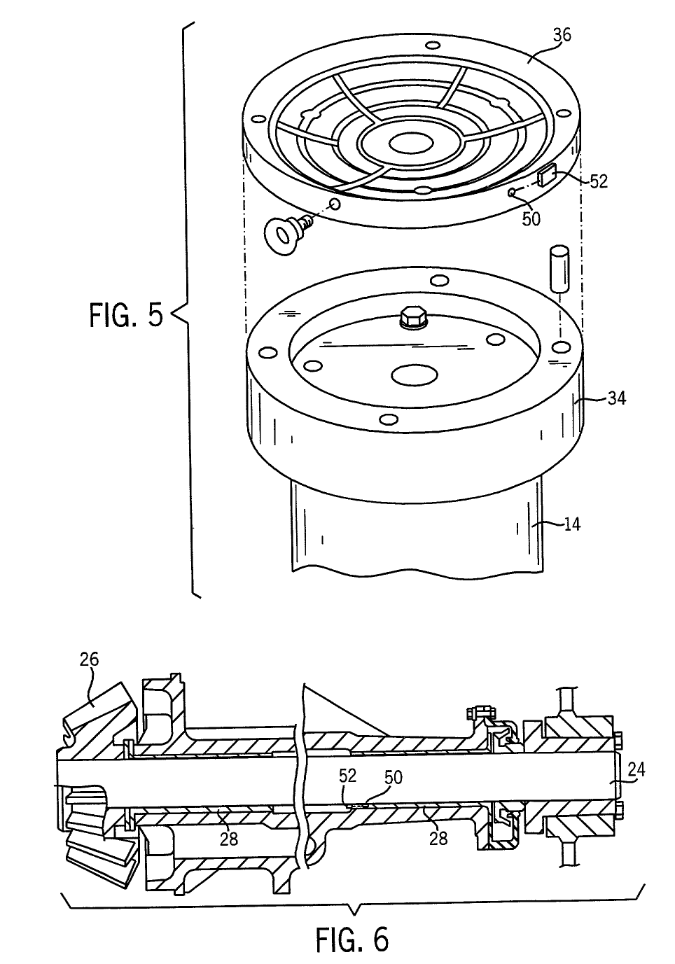

Referring to FIG. 5, socket liner 36 supports head 30 during crusher 10 operation and accordingly is subject to high heat stress. Therefore, it may be desirable to utilize temperature sensor 50 and wireless transmitter 52 to directly measure the temperature of socket liner 36.

Referring to FIG. 6, temperature sensor 50 and wireless transmitter 52 may be useful for directly measuring the temperature of countershaft bushing 28. Temperature sensor 50 may be disposed where heat build-up is problematic, and wireless transmitter 52 may be placed in a location convenient for receiving data from temperature sensor 50.

Referring to FIGS. 3 through 6, wireless transmitter 52 may be secured to any number of locations on the various devices having temperature sensors 50. In an exemplary embodiment, wireless transmitter 52 may be located on a rotating flat edge of eccentric bushing 18. Alternatively, when measuring the temperature of eccentric bushing 18, wireless transmitter 52 may be placed on a co-rotating flat edge of eccentric 16. With reference to FIG. 2, another possible location of wireless transmitter 52 is in the space between the bottom edge of eccentric bushing 18, the thrust bearing 20 and the main shaft 14. In an alternative embodiment, the wireless transmitter 52 may be located on the external surface of the bottom end of the eccentric 16 using a drilled miniature access hole in the eccentric 16.

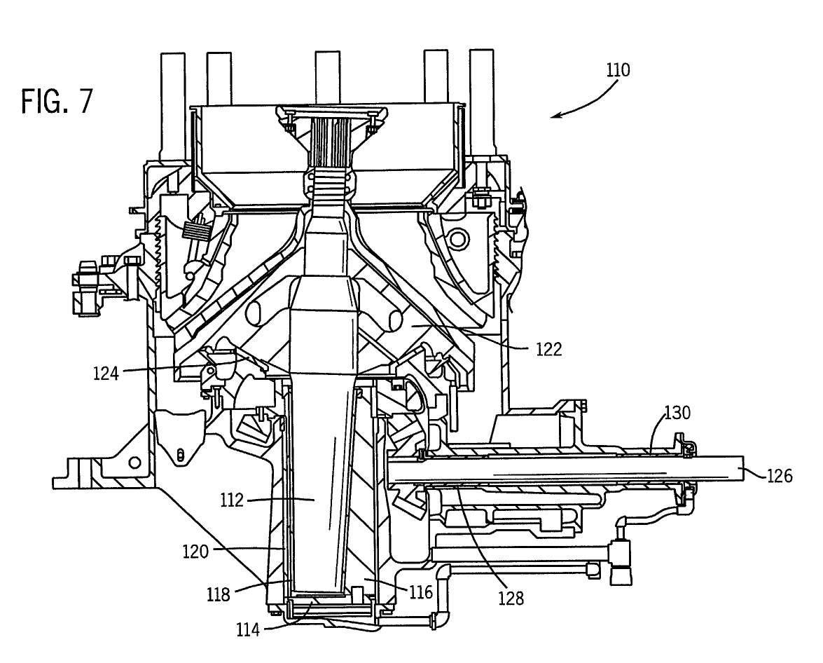

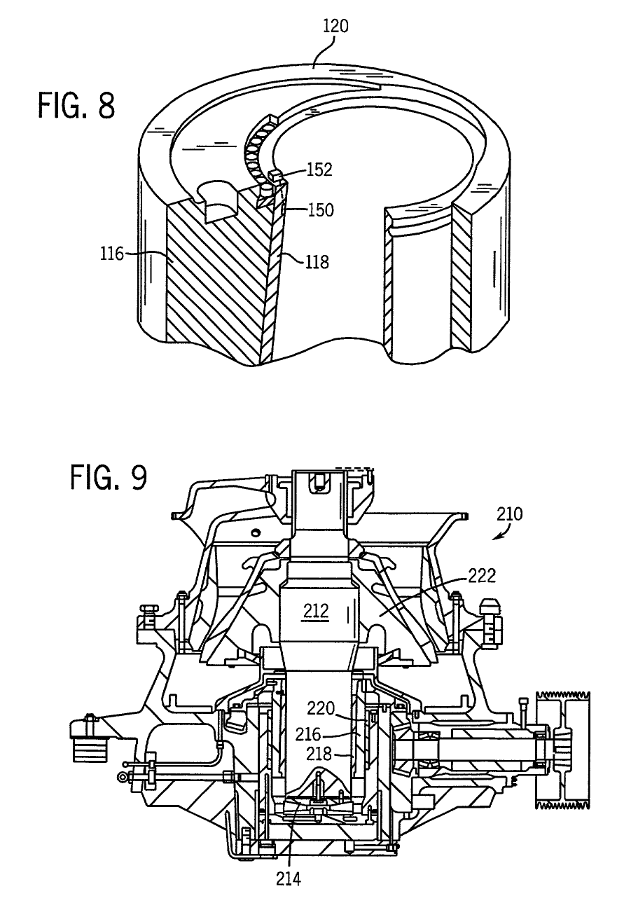

Referring to FIGS. 7 and 8, an alternative embodiment is depicted showing a crusher 110 that may utilize the wireless monitoring of the present invention. Crusher 110 includes a main shaft 112 supported by a thrust bearing plate 114. An eccentric 116 rotates about main shaft 112, producing gyratory motion of main shaft 112. An inner eccentric bushing 118 and an outer eccentric bushing 120 are disposed on the radial inner side and outer side of eccentric 116, permitting the rotational motion of eccentric 116. A head 122 is disposed on main shaft 112 and is slidingly supported by socket liner 124. A countershaft 126 drives the eccentric 116, and is journaled within inner countershaft bushing 128 and outer countershaft bushing 130.

Further referring to FIGS. 7 and 8, direct temperature measurement of inner eccentric bushing 118 and outer eccentric bushing 120 may be desirable to prevent thermal failure. Further, direct temperature measurement may also be desired for socket liner 124, thrust bearing plate 114, inner countershaft bushing 128, and outer countershaft bushing 130. In each of the aforementioned locations, a temperature sensor 150 and wireless transmitter 152 combination (shown utilized on inner eccentric bushing 118 in FIG. 8) may be utilized to avoid the problems associated with conventional temperature sensing methodologies.

Referring to FIG. 9, an alternative crusher 210 is depicted. Crusher 210 includes a main shaft 212 axially supported by a thrust bearing plate 214. An eccentric 216 imparts gyratory motion to main shaft 112 and rotates along with eccentric bushing 218 and frame bushing 220. Head 222 is disposed on main shaft 212 and accordingly gyrates along with main shaft 212.

Further referring to FIG. 9, the temperature sensor and wireless transmitter combination of the present invention (not depicted in FIG. 9) may be utilized to directly measure the temperature of thrust bearing plate 214, frame bushing 220, and eccentric bushing 218 of crusher 210.

In addition to the crusher embodiments depicted in FIGS. 1, 7, and 9, temperature sensors in conjunction with wireless transmitters may be utilized in other crushing devices, such as, but not limited to, other conical gyratory crushers and any crusher using an oscillatory crushing member for accomplishing crushing action, such as, but not limited to, jaw crushers. Further, wireless transmitter 52 may be utilized in conjunction with other sensors to directly measure other environmental variables such as stress, rotational speed, force, strain, displacement, flow rate, and distance.

In addition to bushings and the other crusher parts discussed above, wireless transmitter 52 may be utilized with sensors on other parts, such as liners, gears, or other structural members of crushers.

Accordingly, the invention described herein addresses the disadvantages of the conventional art described in the Background of the Invention section. Temperature sensor 50 and wireless transmitter 52 permit direct temperature measurement of components of rock crushers that are subject to failure due to high heat loads. The utilization of wireless transmitter 52 permits the placement of temperature sensor 50 on moving parts of crushers where hard wired temperature sensors are not possible. The various embodiments of the present invention permit direct measurement of material temperature, thus avoiding the pitfalls associated with indirect temperature measurement such as the necessity to create a predictive correlation between the indirect temperature and impending material failure. In particular, the accuracy of the temperature measurement is improved. Furthermore, the temperature sensor and wireless transmitter of the present invention may be placed in a variety of locations on the devices requiring temperature measurement. The sensor and transmitter can be combined as one wireless unit. Overall, the present invention will improve operational uptime of rock crushers by avoiding component failures.

While the detailed drawings and specific examples given describe preferred and exemplary embodiments of the invention, they serve the purpose of illustration only. The inventions disclosed are not limited to the specific form shown. For example, the wireless transmitter and temperature sensor of the present invention may be utilized in many locations on a rock crusher where direct temperature measurements are desired and difficult to make utilizing hardwired sensors. The crusher configurations shown and described may differ depending on the chosen performance characteristics and physical characteristics of the rock crushers. Furthermore, other substitutions, modifications, changes, and omissions may be made in the design, operating conditions, and arrangement of the exemplary embodiments without departing from the scope of the invention as expressed in the appended claims.

What is claimed is:

1. A cone crusher, comprising:
a frame;
a shaft supported by the frame;
a head coupled to the shaft;
an eccentric rotatably coupled to the shaft;
an eccentric bushing coupled to the eccentric;
a temperature sensor attached to the eccentric bushing, the temperature sensor measuring the temperature of the eccentric bushing; and
a wireless transmitter coupled to the temperature sensor, wherein the wireless transmitter transmits measured temperature data.

2. The cone crusher of claim 1, wherein the eccentric bushing is disposed radially inward of the eccentric.

3. The cone crusher of claim 1, wherein the eccentric bushing is disposed radially outward of the eccentric.

4. The cone crusher of claim 1, wherein the temperature sensor is embedded into the eccentric bushing.

5. The cone crusher of claim 1, wherein the temperature sensor is a thin film metallic sensor.

6. The cone crusher of claim 1, wherein the temperature sensor is a fiberoptic sensor.

7. The cone crusher of claim 1, wherein the wireless transmitter is attached to a flat edge of the eccentric bushing.

8. The cone crusher of claim 1, wherein the wireless transmitter is attached to the eccentric.

9. The cone crusher of claim 1, further comprising a receiver for receiving the measured temperature data from the wireless transmitter.

10. A rock crusher, comprising:
a frame;
a crushing head;
a motive force coupled to the crushing head to effectuate motion designed to crush rock;
a bushing provided intermediate a rotating part and a stationary part of the rock crusher, wherein the bushing rotates with the rotating part, the bushing including a temperature sensor that directly measures the temperature of the bushing; and
a wireless transmitter coupled to the temperature sensor, wherein the wireless transmitter transmits temperature data.

11. The rock crusher of claim 10, wherein the rock crusher is a cone crusher.

12. The rock crusher of claim 10, wherein the rock crusher is a jaw crusher.

13. The rock crusher of claim 10, wherein the rock crusher is a gyratory crusher.

14. The rock crusher of claim 10, wherein the rotating part is an eccentric and the stationary part is a shaft.

15. The rock crusher of claim 10, wherein the rotating part is an eccentric and the stationary part is the frame.

16. The rock crusher of claim 10, wherein the rotating part is a countershaft and the stationary part is a countershaft box.

17. The rock crusher of claim 10, wherein the bushing is a head bushing.

18. The rock crusher of claim 10, wherein the temperature sensor is embedded into the bushing.

19. The rock crusher of claim 10, wherein the temperature sensor is a thin film metallic sensor.

20. The rock crusher of claim 10, wherein the temperature sensor is a fiberoptic sensor.

21. The rock crusher of claim 10, further comprising a receiver for receiving the temperature data from the wireless transmitter.

22. A method of directly measuring the temperature of a moving part within a cone crusher having a frame, a shaft, and a crushing head, comprising the steps of:
embedding a temperature sensor in the moving part;
coupling a wireless transmitter to the temperature sensor;
directly measuring the temperature of the moving part; and
transmitting the temperature from the wireless transmitter to a receiver.

23. The method of claim 22, wherein the moving part is a thrust bearing.

24. The method of claim 22, wherein the moving part is a head ball.

25. The method of claim 22, wherein the moving part is an eccentric bushing.

26. The method of claim 22, wherein the moving part is a countershaft bushing.

27. The method of claim 22, wherein the moving part is a head bushing.

28. The method of claim 22, further comprising the step of reducing the temperature of the moving part when the temperature reaches a preset level.

29. An eccentric bushing for a rock crusher, comprising:
a bushing;
a temperature sensor embedded in the bushing; and
a wireless transmitter attached to the bushing and coupled to the temperature sensor.

30. The eccentric bushing of claim 29, wherein the temperature sensor is a thin film metallic sensor.

31. The eccentric bushing of claim 29, wherein the temperature sensor is a fiberoptic sensor.

32. The eccentric bushing of claim 29, wherein the wireless transmitter is attached to a flat edge of the bushing.

33. The eccentric bushing of claim 29, wherein the temperature sensor is embedded at least one-half inch into the bushing.

34. The eccentric bushing of claim 29, wherein the wireless transmitter is attached to the bushing via an adhesive.

35. The eccentric bushing of claim 29, wherein the wireless transmitter is attached to the bushing by a mechanical fastener.

36. A method of crusher temperature monitoring for the purpose of proactively enhancing crusher operational time, comprising the steps of:
measuring the temperature of a crusher component;
transmitting the measured temperature via a wireless transmitter disposed on the crusher component; and
receiving the transmitted temperature data at a satellite receiver in a remote location.

37. The method of claim 36, wherein the crusher component is a bushing.

38. The method of claim 36, wherein the crusher component is a gear.

39. The method of claim 36, wherein the crusher component is a liner.

40. The method of claim 36, wherein the crusher component is a thrust bearing.

41. A method of monitoring rock crusher operational parameters, comprising the steps of:
incorporating a monitoring device in a rock crusher part;
measuring a rock crusher operational parameter; and
transmitting the measured rock crusher operational parameter to a receiver via a wireless transmitter disposed in the rock crusher part.

42. The method of claim 41, wherein the rock crusher operational parameter is rotational speed.

43. The method of claim 41, wherein the rock crusher operational parameter is displacement.

44. The method of claim 41, wherein the rock crusher operational parameter is fluid flow rate.

45. The method of claim 41, wherein the rock crusher operational parameter is strain data.

46. A cone crusher, comprising:
a frame;
a crushing head;
a bushing provided intermediate a rotating part and a stationary part, wherein the bushing rotates with the rotating part;
a sensor embedded in the bushing that directly measures at least one variable; and
a wireless transmitter coupled to the sensor, wherein the wireless transmitter transmits data associated with the variable.

47. The cone crusher of claim 46, wherein the sensor is a fiberoptic sensor.

48. The cone crusher of claim 47, wherein the sensor directly measures up to four variables.

49. The cone crusher of claim 46, wherein the variable is temperature, stress, rotational speed, force, strain, displacement, flow rate, or distance.

50. A method of monitoring rock crusher operational parameters, comprising the steps of:
incorporating a monitoring device in a rock crusher part;
measuring a rock crusher operational parameter; and
transmitting the measured rock crusher operational parameter to a receiver via at least one wireless transmitter disposed in the rock crusher part.

51. The method of claim 50, wherein the rock crusher operational parameter is rotational speed.

52. The method of claim 50, wherein the rock crusher operational parameter is displacement.

53. The method of claim 50, wherein the rock crusher operational parameter is fluid flow rate.

54. The method of claim 50, wherein the rock crusher operational parameter is strain data.
